(19) United States
(12) Patent Application Publication
(10) Pub. No.: US 2017/0195504 A1
(43) Pub. Date: Jul. 6, 2017

(54) MOBILE INFORMATION PROCESSING DEVICE, IMAGE OUTPUT DEVICE, IMAGE OUTPUT SYSTEM, IMAGE READING DEVICE, IMAGE READING SYSTEM, AND NON-TRANSITORY COMPUTER READABLE MEDIUM

(71) Applicant: FUJI XEROX CO., LTD., Tokyo (JP)

(72) Inventor: Hiroshi YAMAGUCHI, Kanagawa (JP)

(73) Assignee: FUJI XEROX CO., LTD., Tokyo (JP)

(21) Appl. No.: 15/224,815

(22) Filed: Aug. 1, 2016

(30) Foreign Application Priority Data
Jan. 5, 2016 (JP) 2016-000501

(51) Int. Cl. H04N 1/00

(52) U.S. Cl. CPC H04N 1/00095; H04N 1/00307; H04N 2201/0094; H04N 2201/0041; H04N 2201/0053

(57) ABSTRACT

A mobile information processing device includes a transmitting unit and a providing unit. The transmitting unit transmits a print instruction to a light-receiving unit of an image output device via visible light communication. The providing unit suggests to a user an operation of projecting visible light onto the image output device when the print instruction is to be transmitted to the light-receiving unit via the visible light communication.

### CROSS-REFERENCE TO RELATED APPLICATIONS

This application is based on and claims priority under 35 USC 119 from Japanese Patent Application No. 2016-000501 filed Jan. 5, 2016.

### BACKGROUND

(i) Technical Field

The present invention relates to a mobile information processing device, an image output device, an image output system, an image reading device, an image reading system, and a non-transitory computer readable medium.

(ii) Related Art

It is common to issue a print instruction from a mobile information processing device and to perform printing by using an image output device.

However, it is not common to transmit the print instruction to the image output device via visible light communication.

### SUMMARY

According to an aspect of the invention, there is provided a mobile information processing device including a transmitting unit and a providing unit. The transmitting unit transmits a print instruction to a light-receiving unit of an image output device via visible light communication. The providing unit suggests to a user an operation of projecting visible light onto the image output device when the print instruction is to be transmitted to the light-receiving unit via the visible light communication.

### BRIEF DESCRIPTION OF THE DRAWINGS

Exemplary embodiments of the present invention will be described in detail based on the following figures, wherein:

FIG. 1 is a conceptual module configuration diagram of an example configuration of a first exemplary embodiment;

FIGS. 2A and 2B1 through 2B4 illustrate an example configuration of a system according to the first exemplary embodiment;

FIG. 3 is a flowchart illustrating an example process according to the first exemplary embodiment;

FIG. 4 is a flowchart illustrating the example process according to the first exemplary embodiment;

FIG. 5 illustrates an example process according to the first exemplary embodiment;

FIG. 6 illustrates an example process according to the first exemplary embodiment;

FIG. 7 illustrates an example process according to the first exemplary embodiment;

FIG. 8 illustrates an example process according to the first exemplary embodiment;

FIG. 9 illustrates an example process according to the first exemplary embodiment;

FIG. 10 is a conceptual module configuration diagram of an example configuration of a second exemplary embodiment;

FIGS. 11A and 11B1 through 11B4 illustrate an example configuration of a system according to the second exemplary embodiment;

FIG. 12 is a flowchart illustrating an example process according to the second exemplary embodiment;

FIG. 13 is a flowchart illustrating the example process according to the second exemplary embodiment;

FIG. 14 illustrates an example process according to the second exemplary embodiment;

FIG. 15 illustrates an example process according to the second exemplary embodiment;

FIG. 16 illustrates an example process according to the second exemplary embodiment;

FIG. 17 illustrates an example process according to the second exemplary embodiment;

FIG. 18 illustrates an example process according to the second exemplary embodiment; and

FIG. 19 is a block diagram illustrating an example hardware configuration of a computer that implements the first and second exemplary embodiments.

### DETAILED DESCRIPTION

Some exemplary embodiments of the present invention will be described hereinafter with reference to the drawings.

### First Exemplary Embodiment

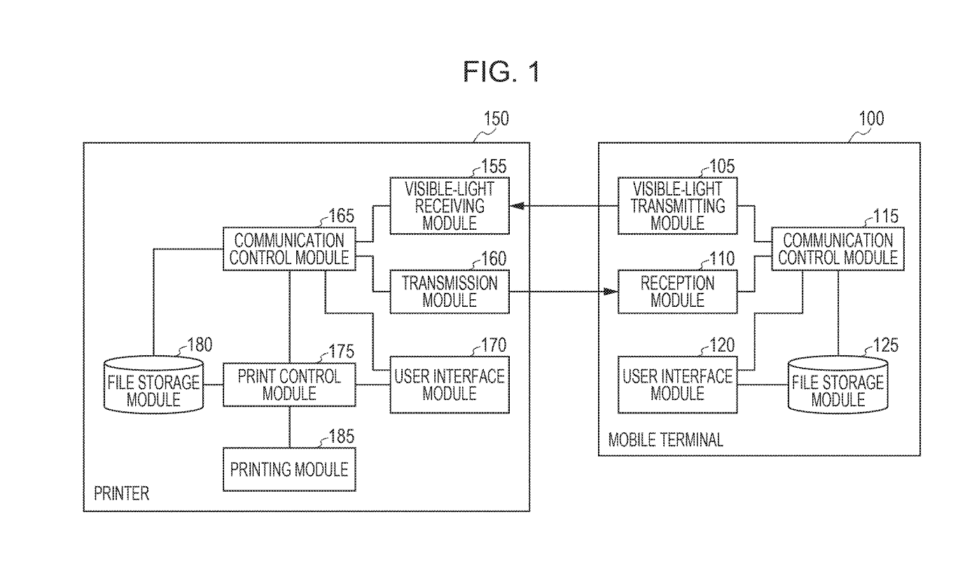

FIG. 1 is a conceptual module configuration diagram illustrating an example configuration of a first exemplary embodiment.

The term “module” generally refers to a logically separable component such as software (computer program) or hardware. Thus, each module in this exemplary embodiment refers not only to a module in a computer program but also to a module in a hardware configuration. Accordingly, this exemplary embodiment is also directed to a computer program for causing a computer to function as these modules (i.e., a program for causing the computer to execute the respective procedures, a program for causing the computer to function as the respective units, or a program for causing the computer to implement the respective functions), as well as to a system and a method. While the expressions “store data” and “data is stored” and their equivalent expressions are used for convenience of description, such expressions have a meaning of making a storage device store data or controlling a storage device to store data if an exemplary embodiment is directed to a computer program. While each module may be given a single function, each module may be constituted by a single program or multiple modules may be constituted by a single program in actual implementation. Conversely, a single module may be constituted by multiple programs. In addition, multiple modules may be executed by a single computer, or a single module may be executed by multiple computers in a distributed or parallel environment. As an alternative, a single module may include another module. In the following, the term “connection” refers not only to a physical connection but also to a logical connection (such as exchanging of data, sending instructions, and a reference relationship between data). The term “predetermined” refers to a state in which certain information is determined before intended processing is to be performed, and is used to include a state in which such information is determined at a time point prior to the commencement of processing according to this exemplary embodiment but also a state in which the information is determined at a time point prior to intended processing even after the processing according to this exemplary embodiment has commenced, depending on the condition or the state at that time or depending on the condition or the state until that time. When there are multiple “predetermined values”, the values may be different or two or more (or all) of the values may be identical. A description having a meaning of “if A, then B” is used to mean: “it is determined whether or not A, and B if it is determined that A” unless the determination of whether or not A is required.

Furthermore, the term “system” or “device” is used to include a configuration in which multiple computers, hardware components, devices, or other suitable elements are connected to each other via a communication medium such as a network (including one-to-one communication connections), and what is implemented by a single computer, hardware component, device, or suitable element. The terms “device” and “system” are used synonymously. It is to be understood that the term “system” does not include what is merely a social “mechanism” (social system), which is a kind of artificial arrangement.

Moreover, target information is read from a storage device for each processing operation that is to be performed by an individual module or, if multiple processing operations are to be performed within a module, for each of the multiple processing operations. After the processing is performed, the result of the processing is written to the storage device. Thus, the reading of information from the storage device before the processing of the information is to be performed and the writing of information to the storage device after the processing of the information has been performed may not be described. Examples of the storage device used here may include a hard disk, a random access memory (RAM), an external storage medium, a storage device connected via a communication line, and a register within a central processing unit (CPU).

The first exemplary embodiment provides a configuration including a mobile terminal 100 and a printer 150. The mobile terminal 100 issues a print instruction (also referred to as “print job”) to the printer 150. The printer 150 performs printing upon receipt of a print instruction from the mobile terminal 100. For example, in a setting in which a user temporarily uses the printer 150 (such as in the case where the user uses the printer 150 one time in a location during a business trip), it may be bothersome for the user to set settings for establishing communication between the mobile terminal 100 and the printer 150, and keeping such settings may give rise to an issue regarding security. The first exemplary embodiment may enable the user to give, even in this case, a print instruction by using their mobile terminal 100, without performing communication setting, to allow the printer 150 to perform printing.

Visible light communication is employed as communication between the mobile terminal 100 and the printer 150 (in particular, at least communication from the mobile terminal 100 to the printer 150).

Visible light communication is communication that uses visible light emitted from an illumination source such as a light-emitting diode (LED) and modulated by changing parameters of the visible light (the parameters including the intensity, frequency, and amplitude of the visible light, and how often to emit the visible light). The following are examples of standards for visible light communication.

JEITA CP-1221/1222/1223 (Japan Electronics and Information Technology Industries Association)

These standards are used principally for illumination-light communication with 4.8 kbps each way.

JEITA CP-1221 Visible Light Communications System, March 2007

http://www.jeita.or.jp/japanese/standard/book/CP-1221

JEITA CP-1222 Visible Light ID System, June 2007

http://www.jeita.or.jp/japanese/standard/book/CP-1222

JEITA CP-1223 Visible Light Beacon System, May 2013

http://www.jeita.or.jp/japanese/standard/book/CP-1223

The standards listed above provide various applications, such as identifying an object, providing position information, and establishing various guidance systems, by causing a visible light source to transmit via radiation brief information or ID information specific to the visible light source.

ARIB STD-T50 Ver. 4.0 (Association of Radio Industries and Businesses), December 2009

This standard is that for optical local area network (LAN) (visible-light extension of infrared light LAN) that uses visible light for downlink and infrared light for uplink.

http://www.arib.or.jp/english/html/overview/doc/1-STD-T50v4_0.pdf

IrDA “Visible Light Communication Standard” Ver. 1.0 (the joint cooperative agreement between the Visible Light Communications Consortium (VLCC) and the Infrared Data Association (IrDA)), February 2009

This standard is that which is an extension to and compatible with IrDA visible light communication technology.

Institute of Electrical and Electronics Engineers (IEEE) 802.15.7 (January 2009)

This standard is a visible light communication standard that has been released.

IEEE 802.15.SG7a

This standard is a visible light communication standard that uses image sensors.

The mobile terminal 100 emits light for visible light communication to the printer 150, and transmits a print instruction to the printer 150. The printer 150 receives the light from the mobile terminal 100 to receive the print instruction.

When a print instruction is to be transmitted from the mobile terminal 100 to the printer 150 via visible light communication, the mobile terminal 100 does not receive an operation of selecting the destination of the print instruction.

Communication setting information on the mobile terminal 100 (for example, setting information necessary for wireless communication such as WiFi) may not necessarily be transmitted to the printer 150. Communication setting information on the mobile terminal 100 may not necessarily be set in the printer 150 even if the communication setting information has been transmitted from the mobile terminal 100, as well as if the communication setting information has not been transmitted from the mobile terminal 100.

As in the example illustrated in FIG. 1, the mobile terminal 100 includes a visible-light transmitting module 105, a reception module 110, a communication control module 115, a user interface module 120, and a file storage module 125. The mobile terminal 100 is typically a portable device, examples of which include mobile phones (including smartphones), notebook personal computers (PCs), and wearable terminals (e.g., wristwatch-type terminals and glasses-type terminals). The mobile terminal 100 is capable of visible light communication (at least visible light communication for transmission), and is designed to transmit a print instruction to the printer 150 in accordance with a user operation.

The visible-light transmitting module 105 is connected to the communication control module 115. The visible-light transmitting module 105 is controlled by the communication control module 115 to modulate visible light parameters for visible light communication and emit light to transmit a print instruction to the printer 150.

The visible-light transmitting module 105 may transmit a print instruction to the printer 150 without accepting an operation of the user for selecting the printer 150, which is the destination of the print instruction. This eliminates the need for the user to select the address, name, and the like of the printer 150 at the other end of the communication, which would be necessary for general wireless communication. In addition, the mobile terminal 100 may not necessarily store communication setting information (for example, the address, name, and the like of the printer 150) necessary for communication with the printer 150.

Further, the visible-light transmitting module 105 may be oriented in the same direction as the direction in which a camera included in the mobile terminal 100 points. In this case, an image captured with the camera may be displayed on a display of the user interface module 120 to allow the user to understand the destination at which the visible light communication is received (i.e., the printer 150).

The reception module 110 is connected to the communication control module 115. The reception module 110 receives information transmitted from the printer 150. The reception module 110 may be a visible light communication receiver or any other communication device. For example, the reception module 110 may be a device supporting WiFi, Bluetooth (registered trademark), which is a standard for short-range wireless communication, or any other suitable technology.

The communication control module 115 is connected to the visible-light transmitting module 105, the reception module 110, the user interface module 120, and the file storage module 125. The communication control module 115 transmits a print instruction to the printer 150 through the visible-light transmitting module 105 via visible light communication. Visible light communication allows the source from which the visible light communication originates, the destination at which the visible light communication is received (i.e., the printer 150), and a communication path to be visible to the user, facilitating the user's understanding of the communication range.

The communication control module 115 may transmit a print instruction multiple times to reduce the risk of commencing reception via visible light communication without successfully receiving the header portion of a print instruction. That is, in some cases, visible light communication might commence prior to projecting visible light onto a light-receiving sensor of the printer 150.

In a case where the mobile terminal 100 transmits a print instruction multiple times, a communication control module 165 of the printer 150 determines whether or not the currently received print instruction is identical to the previously received one. If both print instructions are identical, the currently received print instruction may be discarded.

The user interface module 120 is connected to the communication control module 115 and the file storage module 125. The user interface module 120 accepts a user operation made via a touch screen, audio, a line of sight, a gesture, a mouse, a keyboard, or the like. Examples of the user operation include giving a print instruction. Further, the user interface module 120 informs the user of information by using a device such as a liquid crystal display, a speaker, or a vibrator. Upon receipt of information indicating receipt of the print instruction from the printer 150, the user interface module 120 may present the information. The user, who is presented with the information, performs an operation of stopping the visible light communication (such as extinguishing visible light communication light or directing visible light communication light off from the light-receiving sensor of the printer 150). Further, when a print instruction is to be transmitted to the printer 150 via visible light communication, the user interface module 120 may suggest to the user an operation of projecting visible light onto the printer 150. This facilitates the user's understanding of the operation to be performed when a print instruction is to be transmitted to the printer 150 via visible light communication.

The file storage module 125 is connected to the communication control module 115 and the user interface module 120. The file storage module 125 stores a file to be printed. The communication control module 115 may create a print instruction including a file to be printed.

As in the example illustrated in FIG. 1, the printer 150 includes a visible-light receiving module 155, a transmission module 160, the communication control module 165, a user interface module 170, a print control module 175, a file storage module 180, and a printing module 185. The printer 150 may be typically a printer or a device having a printer function, such as a multifunction device (an image processing device having two or more of functions such as scanner, printer, copier, and facsimile functions).

The visible-light receiving module 155 is connected to the communication control module 165. The visible-light receiving module 155 receives modulated visible light from the mobile terminal 100 via visible light communication and demodulates the received light to receive a print instruction.

The transmission module 160 is connected to the communication control module 165. The transmission module 160 transmits information to the mobile terminal 100. The transmission module 160 may be a transmitter for visible light communication or any other communication device. For example, the transmission module 160 may be a device supporting WiFi, Bluetooth, or any other suitable technology.

The communication control module 165 is connected to the visible-light receiving module 155, the transmission module 160, the user interface module 170, the print control module 175, and the file storage module 180. The communication control module 165 receives a print instruction from the mobile terminal 100 through the visible-light receiving module 155 via visible light communication.

The communication control module 165 may be configured not to set communication setting information on the mobile terminal 100 from which the print instruction has been transmitted via visible light communication. Needless to say, when the communication setting information on the mobile terminal 100 has not been transmitted, the communication setting information on the mobile terminal 100 is not set. Even if the communication setting information on the mobile terminal 100 has been transmitted, the communication setting information on the mobile terminal 100 is not set. The reason for this is to prevent information on the mobile terminal 100 from being left in the printer 150.

If the communication setting information has been transmitted from the mobile terminal 100 via wireless communication other than visible light communication, the communication control module 165 uses the communication setting information to perform communication related to the current print instruction via wireless communication other than visible light communication. After the communication related to the current print instruction has been completed, the communication control module 165 deletes the communication setting information from the printer 150.

The communication control module 165 may also be configured not to transmit to the mobile terminal 100 information indicating that the visible-light receiving module 155 has received a print instruction from the mobile terminal 100 (for example, a reception completion notification). In this case, one-way communication (or one-sided communication) from the mobile terminal 100 to the printer 150 may be performed.

The user interface module 170 is connected to the communication control module 165 and the print control module 175. The user interface module 170 accepts a user operation made via a touch screen, audio, a line of sight, a gesture, a mouse, a keyboard, or the like. Further, the user interface module 170 informs the user of information by using a device such as a liquid crystal display, a speaker, or a vibrator. For example, when a print instruction is to be received from the mobile terminal 100 via visible light communication, the user interface module 170 may suggest to the user an operation of projecting visible light onto the printer 150. This facilitates the user's understanding of the operation to be performed when a print instruction is to be transmitted to the printer 150 via visible light communication.

The print control module 175 is connected to the communication control module 165, the user interface module 170, the file storage module 180, and the printing module 185. The print control module 175 controls the printing module 185 to perform a printing process in accordance with the print instruction received by the communication control module 165.

The file storage module 180 is connected to the communication control module 165 and the print control module 175. The file storage module 180 stores a file included in the print instruction received by the communication control module 165.

The printing module 185 is connected to the print control module 175. The printing module 185 performs a printing process in accordance with control of the print control module 175.

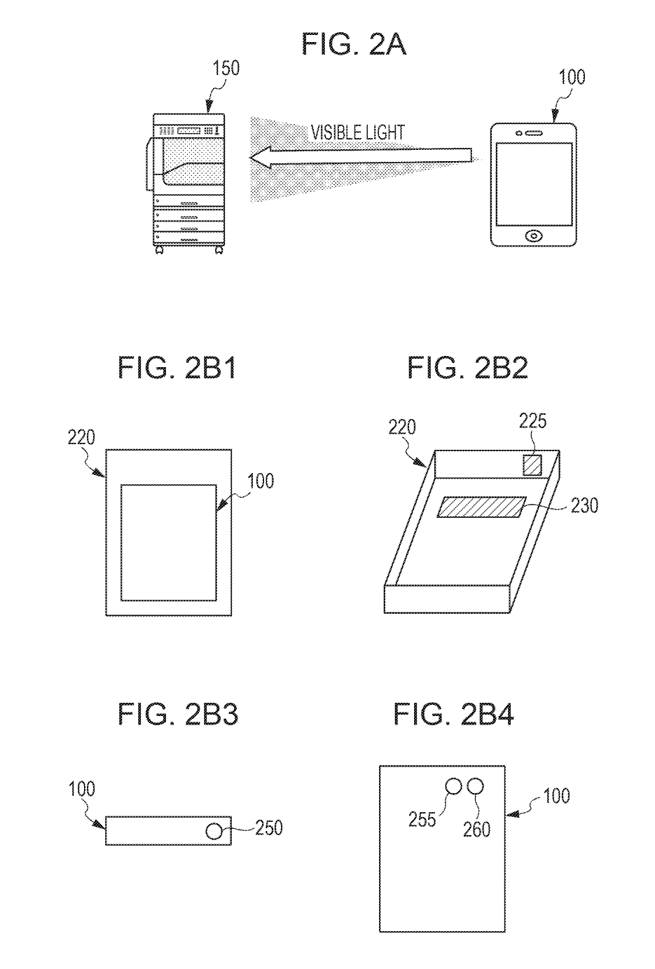

FIGS. 2A and 2B1 through 2B4 illustrate an example configuration and so on of a system according to the first exemplary embodiment.

As in the example illustrated in FIG. 2A, the printer 150 receives visible light communication light from the mobile terminal 100 to receive a print instruction. The printer 150 then prints a file transmitted from the mobile terminal 100. The user extracts a printed sheet from the printer 150.

A visible-light receiving device of the printer 150 is mounted in an area (for example, a front surface portion or a top surface portion) onto which an external device (e.g., the mobile terminal 100) is capable of projecting light.

In the example illustrated in FIG. 2A, the mobile terminal 100 and the printer 150 are kept apart from each other. The mobile terminal 100 and the printer 150 may be placed close to each other if visible light communication is possible therebetween. For example, as illustrated in FIG. 2B1, the printer 150 may have in a top surface portion thereof a mobile terminal seat 220 for accommodating the mobile terminal 100.

For example, as illustrated in FIG. 2B2, the mobile terminal seat 220 may include a visible-light receiving device 225 on an upper side surface thereof. The mobile terminal seat 220 may further include a visible-light receiving device 230 on a bottom surface thereof. The visible-light receiving device 225 may be defined over the entirety of the upper side surface of the mobile terminal seat 220. The visible-light receiving device 230 may be defined over the entirety of the bottom surface of the mobile terminal seat 220. The visible-light receiving device 225 (the visible-light receiving device 230) may be defined on the upper side surface, the right side surface, the left side surface, the lower side surface, or the bottom surface, or may be defined over the entirety thereof. The visible-light receiving device 225 (the visible-light receiving device 230) may be defined so as to match the position of a visible light communication transmitter of the mobile terminal 100.

Alternatively, the visible-light receiving device 225 (the visible-light receiving device 230) may be defined on the entirety (the upper side surface, the lower side surface, the right side surface, the left side surface, and the bottom surface) of the mobile terminal seat 220 in order to support the mobile terminal 100 regardless of how the mobile terminal 100 is placed or the type of the mobile terminal 100.

As in the example illustrated in FIG. 2B3, the mobile terminal 100 may include a visible-light transmitting device 250 on a side surface thereof. As in the example illustrated in FIG. 2B4, the mobile terminal 100 may further include a visible-light transmitting device 255 near a camera 260. In this case, as described above, an image of a device that is to receive the visible light communication (i.e., the printer 150) is captured with the camera 260 and is displayed on a display of the mobile terminal 100 to allow the user to check the entity at the other end of the communication. Additionally, either of an imaging light source (such as an LED light or a strobe light) of a camera and a light-emitting display (liquid crystal display) used for a user interface, which are mounted on the mobile terminal 100, or the like may be used as a light-emitting device for use in visible light communication.

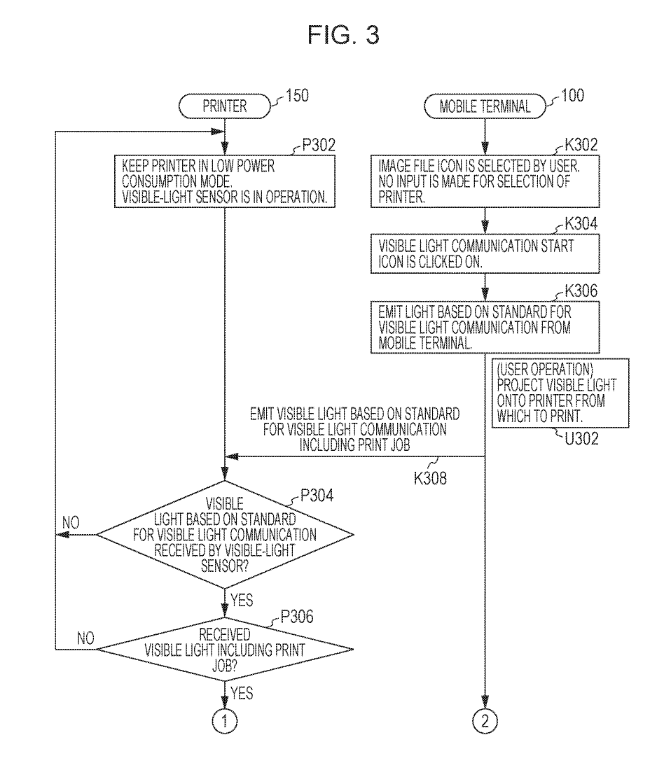

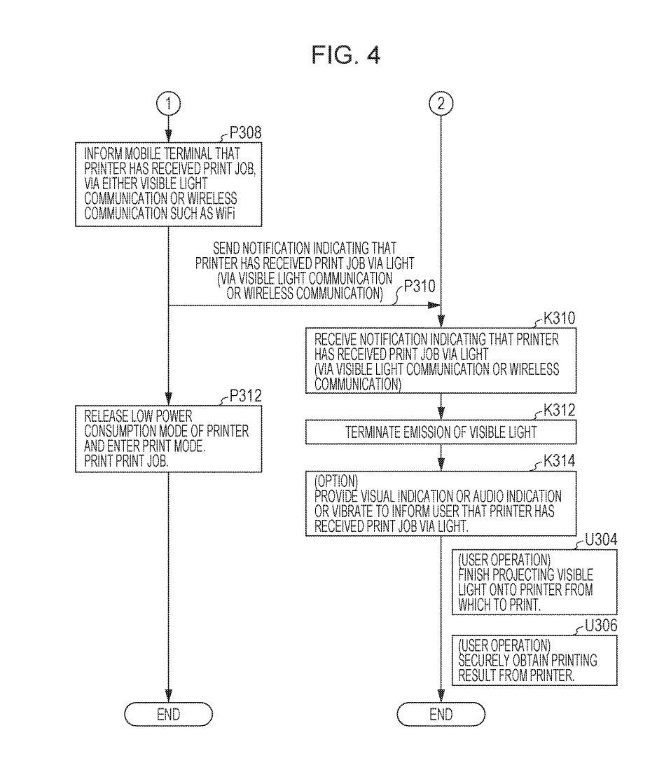

FIGS. 3 and 4 are a flowchart illustrating an example process according to the first exemplary embodiment.

The printer 150 performs the following process.

In step P302, the printer 150 is kept in a low power consumption mode. A visible-light sensor is in operation. The visible-light sensor is waiting for visible light communication to be received.

The process proceeds to step P304 after step K308.

In step P304, the printer 150 determines whether or not the visible-light sensor has received visible light based on the standard for visible light communication. If visible light has been received, the process proceeds to step P306. Otherwise, the process returns to step P302.

In step P306, the printer 150 determines whether or not the received visible light includes a print job. If the visible light includes a print job, the process proceeds to step P308. Otherwise, the process returns to step P302.

In step P308, the printer 150 informs the mobile terminal 100 that the print job has been received via light. The mobile terminal 100 may be informed via visible light communication or via wireless communication such as WiFi.

In step P310, the printer 150 sends a notification (visible light communication or wireless communication) indicating that the printer 150 has received the print job via light to the mobile terminal 100.

In step P312, the printer 150 releases its low power consumption mode and enters a print mode. The printer 150 performs printing in accordance with the print job.

On the other hand, the mobile terminal 100 performs the following process. The operation of the user will also be described using steps U.

In step K302, an image file icon is selected by the user. No input is made for the selection of the printer 150. The mobile terminal 100 may not have registered therein the address of the printer 150. Without the use of the technique of the first exemplary embodiment (with the use of a technique of the related art), the mobile terminal 100 has registered therein the address of the printer 150. Thus, the names of many candidate printers (many printer names) are displayed in a list for the selection of the printer 150, making the selection operation inconvenient. In the first exemplary embodiment, printing is feasible without the need of registering the address of the printer 150 in the mobile terminal 100. It will be understood that the operation of selecting the printer 150 on the display of the mobile terminal 100 is also not necessary.

In step K304, a visible light communication start icon is clicked on to issue an instruction to transmit the image file selected in step K302.

In step K306, the mobile terminal 100 emits light based on the standard for visible light communication.

In step U302, the user projects visible light onto the printer 150 from which to print.

In step K308, the mobile terminal 100 transmits a print job to the printer 150 via visible light based on the standard for visible light communication.

In this case, the address of the mobile terminal 100 for WiFi communication may not necessarily be transmitted to the printer 150. Since wireless communication such as WiFi involves the setup of a connection between the mobile terminal 100 and the printer 150, the address of the mobile terminal 100 is sent to the printer 150 and the printer 150 temporarily stores the address. This may result in the printer 150 being informed of the address of the mobile terminal 100, and may give rise to a concern regarding security. No transmission of the address of the mobile terminal 100 to the printer 150 may mitigate the concern regarding security.

The process proceeds to step K310 after step P310.

In step K310, the mobile terminal 100 receives the notification indicating that the printer 150 has received the print job via light (via visible light communication or wireless communication).

Note that the notification indicating that the printer 150 has received the print job via light may not be transmitted via wireless communication. That is, steps P308 and P310 may be omitted, resulting in step K310 being unnecessary as well. In this case, the user knows successful transmission of the print job by viewing a user interface display on the printer 150. The user then performs an operation of causing the mobile terminal 100 to terminate the emission of visible light. Wireless communication other than visible light communication from the printer 150 to the mobile terminal 100 requires the printer 150 to be informed of the address of the mobile terminal 100. The omission of steps P308 and P310 eliminates this requirement, which may make the operation simple and may eliminate or reduce potential security risks.

In step K312, the mobile terminal 100 terminates the emission of visible light. That is, visible light communication is terminated.

In step K314, the mobile terminal 100 performs a process for informing the user that the printer 150 has received the print job via light (by, for example, visual indication, audio indication, or vibration). Step K314 may be omitted.

Thereafter, user operations are performed as follows.

In step U304, the user finishes projecting visible light being emitted onto the printer 150 from which to print.

In step U306, the user securely obtains a printing result from the printer 150.

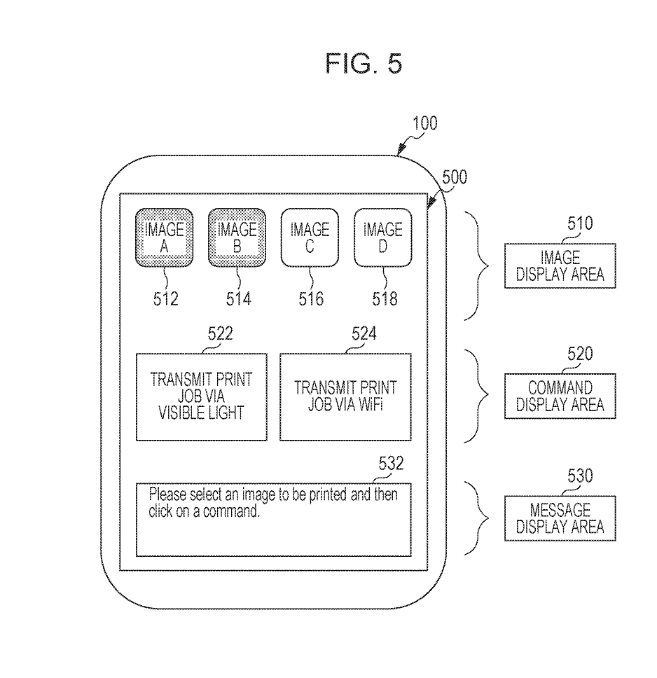

FIGS. 5 to 9 illustrate example displays on the display of the mobile terminal 100 or the printer 150.

FIG. 5 illustrates an example process (performed by the mobile terminal 100) according to the first exemplary embodiment. Specifically, an example display corresponding to steps K302 and K304 in the flowchart is illustrated.

The mobile terminal 100 includes a display 500. The content displayed on the display 500 is illustrated.

The display 500 has three areas: an image display area 510, a command display area 520, and a message display area 530.

The image display area 510 shows an “image A” icon 512, an “image B” icon 514, an “image C” icon 516, and an “image D” icon 518.

The command display area 520 shows a “Transmit print job via visible light” icon 522 and a “Transmit print job via WiFi” icon 524.

The message display area 530 shows a message display area 532. For example, the message “Please select an image to be printed and then click on a command” is displayed in the message display area 532.

The example illustrated in FIG. 5 indicates that the “image A” icon 512 and the “image B” icon 514 have been selected. Thereafter, in response to a click on the “Transmit print job via visible light” icon 522, a transition to step K306 in the flowchart occurs.

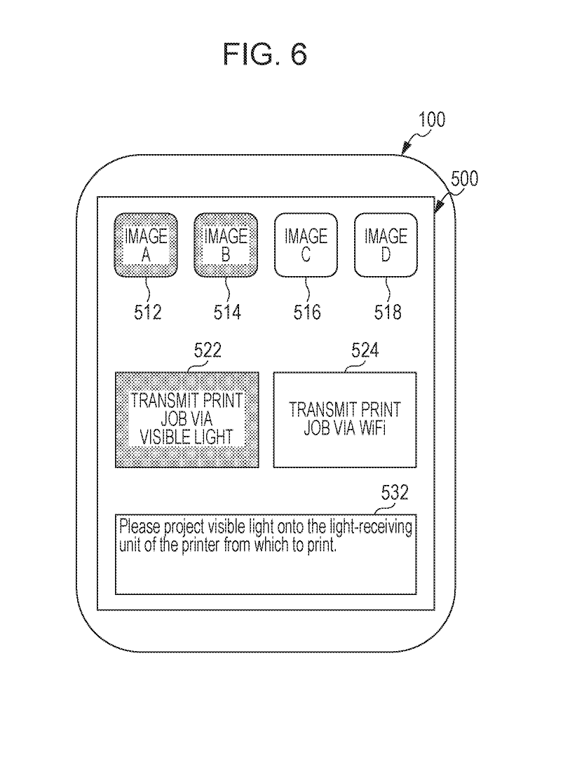

FIG. 6 illustrates an example process (performed by the mobile terminal 100) according to the first exemplary embodiment. Specifically, an example display corresponding to steps K306 and U302 in the flowchart is illustrated.

The “Transmit print job via visible light” icon 522 is being selected by the user.

Upon acceptance of the selection of the “Transmit print job via visible light” icon 522, the mobile terminal 100 emits light based on the standard for visible light communication (step K302). Then, a suggestion for the user to project visible light onto the printer 150 is displayed in the message display area 532 as an operation to be performed by the user. For example, the message “Please project visible light onto the light-receiving unit of the printer from which to print” is displayed in the message display area 532. This display facilitates the user's understanding of the operation to be performed.

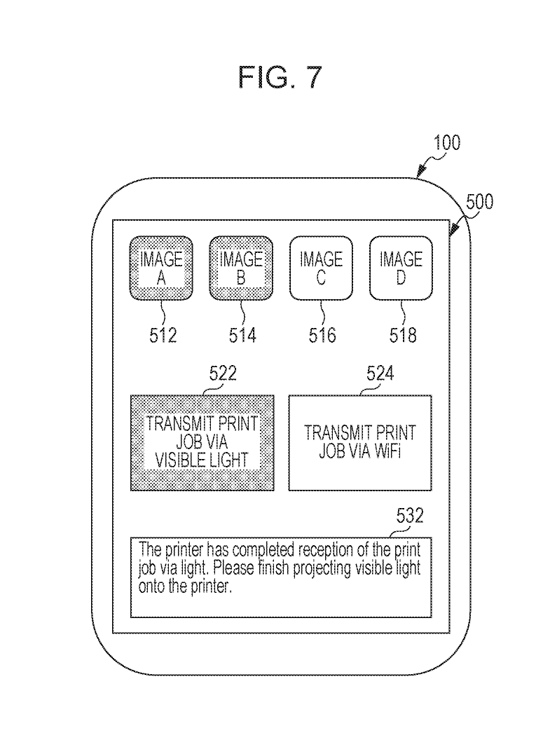

FIG. 7 illustrates an example process (performed by the mobile terminal 100) according to the first exemplary embodiment. Specifically, an example display corresponding to steps K310 to K314 and U304 in the flowchart is illustrated.

The “Transmit print job via visible light” icon 522 is being selected by the user.

The emission of light from the mobile terminal 100 is terminated (step K312). Then, a suggestion for the user to finish projecting visible light onto the printer 150 is displayed in the message display area 532 as an operation to be performed by the user. For example, the message “The printer has completed reception of the print job via light. Please finish projecting visible light onto the printer” is displayed in the message display area 532. This display facilitates the user's understanding of the operation to be performed.

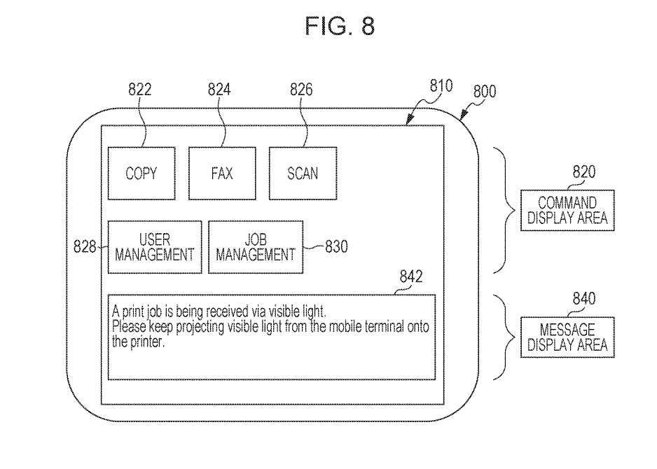

FIG. 8 illustrates an example process (performed by the printer 150) according to the first exemplary embodiment. Specifically, an example display corresponding to steps P304 and P306 in the flowchart is illustrated.

A display device 800 includes a display 810.

The display 810 has a command display area 820 and a message display area 840.

The command display area 820 shows a “copy” icon 822, a “fax” icon 824, a “scan” icon 826, a “user management” icon 828, and a “job management” icon 830.

The message display area 840 shows a message display area 842.

The printer 150 is receiving light based on the standard for visible light communication. Then, a suggestion for the user to project visible light onto the printer 150 is displayed in the message display area 842 as an operation to be performed by the user. For example, the message “A print job is being received via visible light. Please keep projecting visible light from the mobile terminal onto the printer” is displayed in the message display area 842. This display facilitates the user's understanding of the operation to be performed.

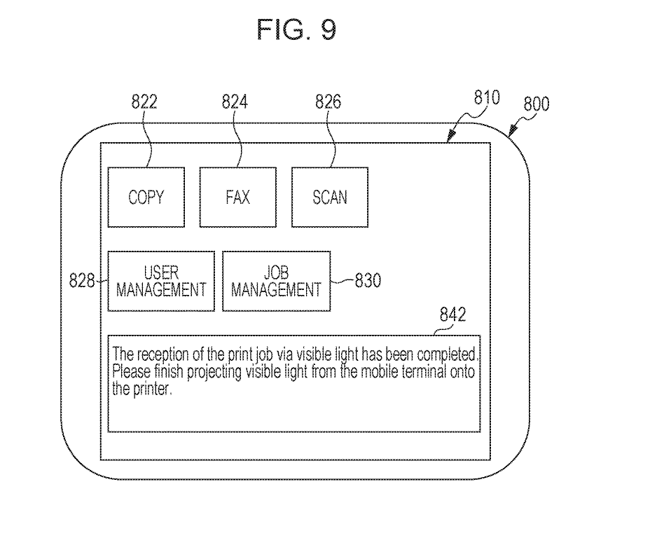

FIG. 9 illustrates an example process (performed by the printer 150) according to the first exemplary embodiment. Specifically, an example display corresponding to step P308 in the flowchart is illustrated.

When the printer 150 completes reception of light, a suggestion for the user to finish projecting visible light onto the printer 150 is displayed in the message display area 842 as an operation to be performed by the user. For example, the message “The reception of the print job via visible light has been completed. Please finish projecting visible light from the mobile terminal onto the printer” is displayed in the message display area 842. This display facilitates the user's understanding of the operation to be performed.

### Second Exemplary Embodiment

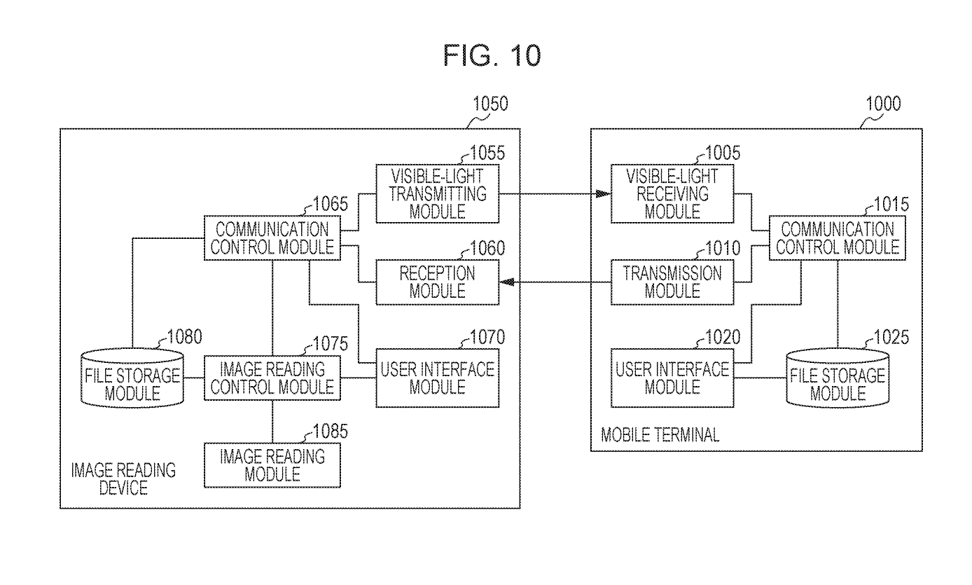

FIG. 10 is a conceptual module configuration diagram illustrating an example configuration of a second exemplary embodiment. In the second exemplary embodiment, an image read by an image reading device 1050 is transmitted to a mobile terminal 1000 via visible light communication in a way opposite to that of the first exemplary embodiment.

The second exemplary embodiment provides a configuration including the mobile terminal 1000 and the image reading device 1050. The mobile terminal 1000 receives an image from the image reading device 1050. The image reading device 1050 reads an image and transmits the image to the mobile terminal 1000. For example, in a setting in which a user temporarily uses the image reading device 1050 (such as in the case where the user uses the image reading device 1050 in a location during a business trip one time), it may be bothersome for the user to set settings for establishing communication between the mobile terminal 1000 and the image reading device 1050 and keeping such settings may give rise to an issue regarding security. The second exemplary embodiment enables the user to receive, even in this case, an image read by the image reading device 1050 by using their mobile terminal 1000 without performing communication setting.

Visible light communication is employed as communication between the mobile terminal 1000 and the image reading device 1050 (in particular, at least communication from the image reading device 1050 to the mobile terminal 1000).

The image reading device 1050 emits light for visible light communication to the mobile terminal 1000, and transmits an image to the mobile terminal 1000. The mobile terminal 1000 receives the light from the image reading device 1050 to receive the image.

When an image is to be transmitted from the image reading device 1050 to the mobile terminal 1000 via visible light communication, the image reading device 1050 does not receive an operation of selecting the destination of the image.

Communication setting information on the image reading device 1050 (for example, setting information necessary for wireless communication such as WiFi) may not necessarily be transmitted to the mobile terminal 1000. Communication setting information on the image reading device 1050 may not necessarily be set in the mobile terminal 1000 even if the communication setting information has been transmitted from the image reading device 1050, as well as if the communication setting information has not been transmitted from the image reading device 1050.

As in the example illustrated in FIG. 10, the mobile terminal 1000 includes a visible-light receiving module 1005, a transmission module 1010, a communication control module 1015, a user interface module 1020, and a file storage module 1025. The mobile terminal 1000 is typically a portable device, examples of which include mobile phones (including smartphones), notebook personal computers (PCs), and wearable terminals (e.g., wristwatch-type terminals and glasses-type terminals). The mobile terminal 1000 is capable of visible light communication (at least visible light communication for reception), and is designed to receive an image from the image reading device 1050 in accordance with a user operation.

The visible-light receiving module 1005 is connected to the communication control module 1015. The visible-light receiving module 1005 receives light for visible light communication. The visible-light receiving module 1005 is controlled by the communication control module 1015 to receive an image from the image reading device 1050 via visible light communication.

The visible-light receiving module 1005 may be oriented in the same direction as the direction in which a camera included in the mobile terminal 1000 points. In this case, an image captured with the camera may be displayed on a display of the user interface module 1020 to allow the user to check the other end of the visible light communication (i.e., the image reading device 1050).

The transmission module 1010 is connected to the communication control module 1015. The transmission module 1010 transmits information to the image reading device 1050. The transmission module 1010 may be a transmitter for visible light communication or any other communication device. For example, the transmission module 1010 may be a device supporting WiFi, Bluetooth, or any other suitable technology.

The communication control module 1015 is connected to the visible-light receiving module 1005, the transmission module 1010, the user interface module 1020, and the file storage module 1025. The communication control module 1015 receives an image from the image reading device 1050 via visible light communication through the visible-light receiving module 1005. Visible light communication allows the source from which the visible light communication originates (i.e., the image reading device 1050), the destination at which the visible light communication is received, and a communication path to be visible to the user, facilitating the user's understanding of the communication range.

The communication control module 1015 may be configured not to set communication setting information on the image reading device 1050 from which the image has been transmitted via visible light communication.

The communication control module 1015 may also be configured not to transmit to the image reading device 1050 information indicating that the visible-light receiving module 1005 has received the image from the image reading device 1050. In this case, one-way communication (or one-sided communication) from the image reading device 1050 to the mobile terminal 1000 may be performed.

The user interface module 1020 is connected to the communication control module 1015 and the file storage module 1025. The user interface module 1020 accepts a user operation made via a touch screen, audio, a line of sight, a gesture, a mouse, a keyboard, or the like. Examples of the user operation include giving instructions to receive an image. Further, the user interface module 1020 informs the user of information by using a device such as a liquid crystal display, a speaker, or a vibrator.

The file storage module 1025 is connected to the communication control module 1015 and the user interface module 1020. The file storage module 1025 stores an image (file) transmitted from the image reading device 1050.

As in the example illustrated in FIG. 10, the image reading device 1050 includes a visible-light transmitting module 1055, a reception module 1060, a communication control module 1065, a user interface module 1070, an image reading control module 1075, a file storage module 1080, and an image reading module 1085. The image reading device 1050 may be typically a scanner or a device having a scanner function, such as a multifunction device.

The visible-light transmitting module 1055 is connected to the communication control module 1065. The visible-light transmitting module 1055 emits light for visible light communication. The visible-light transmitting module 1055 is controlled by the communication control module 1065 to transmit an image read by the image reading module 1085 to the mobile terminal 1000 via visible light communication.

The visible-light transmitting module 1055 may transmit the image to the mobile terminal 1000 without accepting an operation of the user for selecting the mobile terminal 1000, which is the destination of the image. This eliminates the need for the user to select the address, name, and the like of the mobile terminal 1000 at the other end of the communication, which would be necessary for general wireless communication. In addition, the image reading device 1050 may not necessarily store communication setting information (for example, the address, name, and the like of the mobile terminal 1000) necessary for communication with the mobile terminal 1000.

The reception module 1060 is connected to the communication control module 1065. The reception module 1060 receives information from the mobile terminal 1000. The reception module 1060 may be a visible light communication receiver or any other communication device. For example, the reception module 1060 may be a device supporting WiFi, Bluetooth, or any other suitable technology.

The communication control module 1065 is connected to the visible-light transmitting module 1055, the reception module 1060, the user interface module 1070, the image reading control module 1075, and the file storage module 1080. The communication control module 1065 transmits an image read by the image reading module 1085 to the mobile terminal 1000 via visible light communication. Visible light communication allows the source from which the visible light communication originates, the destination at which the visible light communication is received (i.e., the mobile terminal 1000), and a communication path to be visible to the user, facilitating the user's understanding of the communication range.

The communication control module 1065 may transmit an image multiple times to reduce the risk of commencing reception via visible light communication without successfully receiving the header portion of a transmitted image. That is, in some cases, visible light communication might commence prior to positioning the mobile terminal 1000 to allow visible light to reach a light-receiving sensor of the mobile terminal 1000.

In a case where the image reading device 1050 transmits an image multiple times, the communication control module 1015 of the mobile terminal 1000 determines whether or not the currently received image is identical to the previously received one. If both images are identical, the currently received image may be discarded.

The user interface module 1070 is connected to the communication control module 1065 and the image reading control module 1075. The user interface module 1070 accepts a user operation made via a touch screen, audio, a line of sight, a gesture, a mouse, a keyboard, or the like. Examples of the user operation include giving instructions to transmit an image. Further, the user interface module 1070 informs the user of information by using a device such as a liquid crystal display, a speaker, or a vibrator. Upon receipt of information indicating receipt of an image from the mobile terminal 1000, the user interface module 1070 may present the information. The user, who is presented with the information, performs an operation of stopping the visible light communication (such as positioning the mobile terminal 1000 to prevent visible light communication light from reaching the light-receiving sensor of the mobile terminal 1000).

The image reading control module 1075 is connected to the communication control module 1065, the user interface module 1070, the file storage module 1080, and the image reading module 1085. The image reading control module 1075 causes the image reading module 1085 to read an image.

The file storage module 1080 is connected to the communication control module 1065 and the image reading control module 1075. The file storage module 1080 stores an image (file) read by the image reading module 1085. The image is then passed to the communication control module 1065.

The image reading module 1085 is connected to the image reading control module 1075. The image reading module 1085 reads an image in accordance with control of the image reading control module 1075.

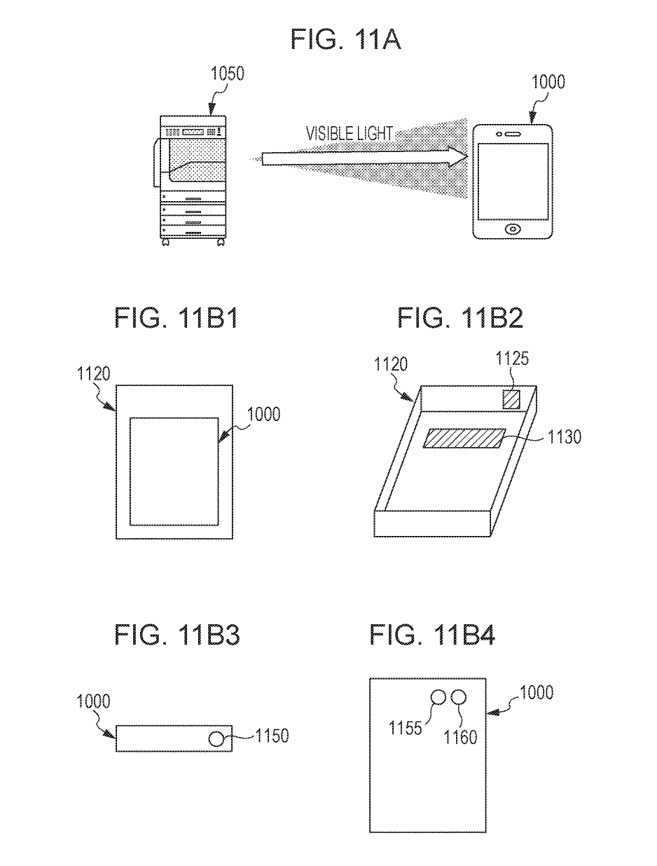

FIGS. 11A and 11B1 through 11B4 illustrates an example configuration and so on of a system according to the second exemplary embodiment.

As in the example illustrated in FIG. 11A, the image reading device 1050 reads an image, and then the mobile terminal 1000 receives light from the image reading device 1050 via visible light communication to receive the image. The received image is displayed on a display of the mobile terminal 1000 to allow the user to check the image.

A visible-light transmitting device of the image reading device 1050 is mounted in an area (for example, a front surface portion or a top surface portion) from which light is capable of being emitted to outside (e.g., the mobile terminal 1000).

In the example illustrated in FIG. 11A, the mobile terminal 1000 and the image reading device 1050 are kept apart from each other. The mobile terminal 1000 and the image reading device 1050 may be placed close to each other if visible light communication is possible therebetween. For example, as illustrated in FIG. 11B1, the image reading device 1050 may have in a top surface portion thereof a mobile terminal seat 1120 of the mobile terminal 1000.

For example, as illustrated in FIG. 11B2, the mobile terminal seat 1120 may include a visible-light transmitting device 1125 on an upper side surface thereof. The mobile terminal seat 1120 may further include a visible-light transmitting device 1130 on a bottom surface thereof. The visible-light transmitting device 1125 may be defined over the entirety of the upper side surface of the mobile terminal seat 1120. The visible-light transmitting device 1130 may be defined over the entirety of the bottom surface of the mobile terminal seat 1120. The visible-light transmitting device 1125 (the visible-light transmitting device 1130) may be defined on the upper side surface, the right side surface, the left side surface, the lower side surface, or the bottom surface, or may be defined over the entirety thereof. The visible-light transmitting device 1125 (the visible-light transmitting device 1130) may be defined so as to match the position of a visible light communication receiver of the mobile terminal 1000.

Alternatively, the visible-light transmitting device 1125 (the visible-light transmitting device 1130) may be defined on the entirety (the upper side surface, the lower side surface, the right side surface, the left side surface, and the bottom surface) of the mobile terminal seat 1120 in order to support the mobile terminal 1000 regardless of how the mobile terminal 1000 is placed or the type of the mobile terminal 1000.

As in the example illustrated in FIG. 11B3, the mobile terminal 1000 may include a visible-light receiving device 1150 on a side surface thereof. As in the example illustrated in FIG. 11B4, the mobile terminal 1000 may further include a visible-light receiving device 1155 near a camera 1160. In this case, as described above, an image of an entity from which visible light communication is transmitted (i.e., the image reading device 1050) is captured with the camera 1160 and is displayed on a display of the mobile terminal 1000 to allow the user to check the entity at the other end of the communication. The camera 1160 may have the function of the visible-light receiving device 1150. In this case, it will be understood that the visible-light receiving device 1150 in the example illustrated in FIG. 11B4 is not necessary and only the camera 1160 is provided.

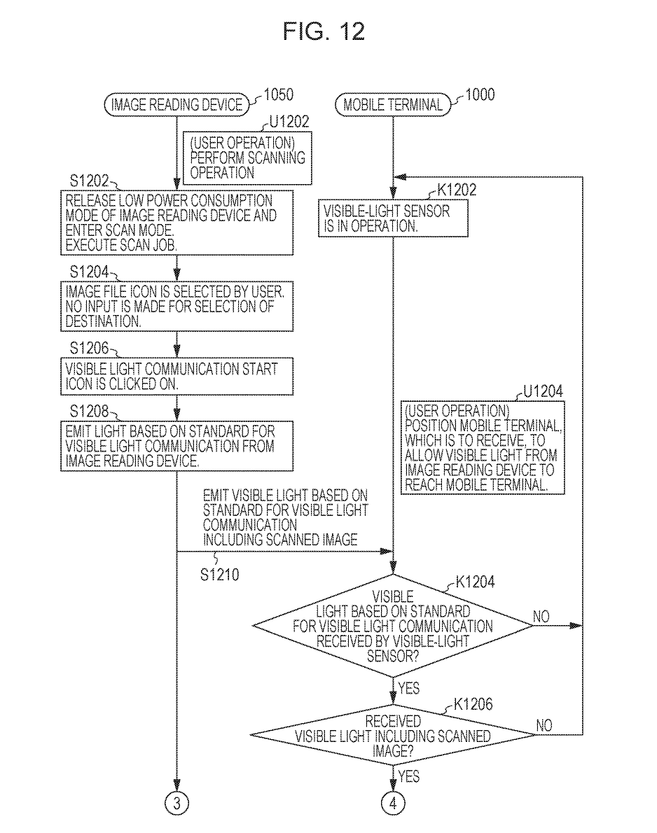

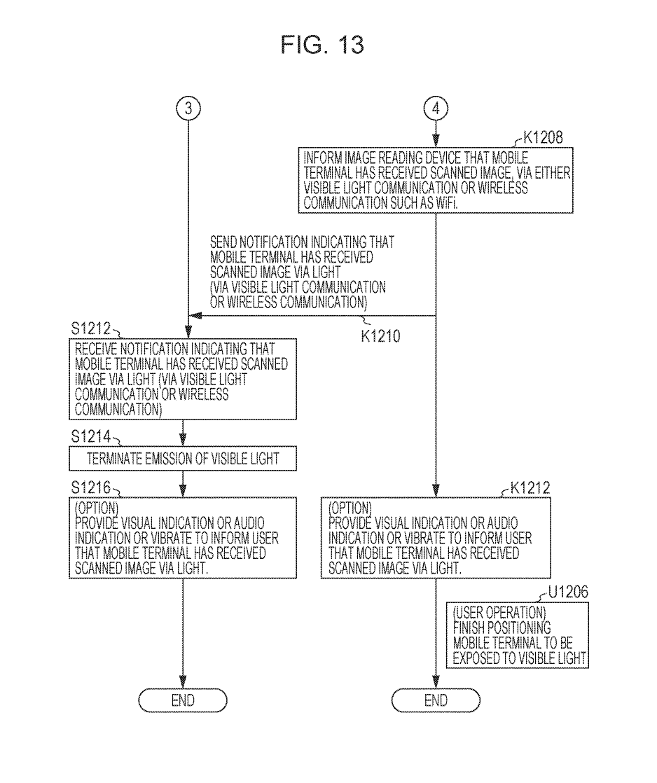

FIGS. 12 and 13 are a flowchart illustrating an example process according to the second exemplary embodiment.

The image reading device 1050 performs the following process. The operation of the user will also be described using steps U.

In step U1202, the user performs a scanning operation.

In step S1202, the scanning operation triggers the image reading device 1050 to release its low power consumption mode and enter a scan mode. The image reading device 1050 then executes a scan job.

In step S1204, an image file icon (an icon indicating a read image) is selected by the user. No input is made for the selection of the mobile terminal 1000, which is the destination. The image reading device 1050 may not have registered therein the address of the mobile terminal 1000. Without the use of the technique of the second exemplary embodiment (with the use of a technique of the related art), the image reading device 1050 has registered therein the address of the mobile terminal 1000. Thus, the names of many candidate mobile terminals are displayed in a list for the selection of the mobile terminal 1000, making the selection operation inconvenient. In the second exemplary embodiment, a scanned image is transferable without the need of registering the address of the mobile terminal 1000 in the image reading device 1050. It will be understood that the operation of selecting the mobile terminal 1000 on the display of the image reading device 1050 is also not necessary.

In step S1206, a visible light communication start icon is clicked on to issue an instruction to transmit the image file read in step S1202.

In step S1208, the image reading device 1050 emits light based on the standard for visible light communication.

In step S1210, the image reading device 1050 transmits a scanned image to the mobile terminal 1000 via visible light based on the standard for visible light communication.

In this case, the address of the image reading device 1050 for WiFi communication may not necessarily be transmitted to the mobile terminal 1000. Since wireless communication such as WiFi involves the setup of a connection between the image reading device 1050 and the mobile terminal 1000, the address of the image reading device 1050 is sent to the mobile terminal 1000 and the mobile terminal 1000 temporarily stores the address. This may result in the mobile terminal 1000 being informed of the address of the image reading device 1050, and may give rise to a concern regarding security. No transmission of the address of the image reading device 1050 to the mobile terminal 1000 may mitigate the concern regarding security.

The process proceeds to step S1212 after step K1210.

In step S1212, the image reading device 1050 receives a notification indicating that the mobile terminal 1000 has received the scanned image via light (via visible light communication or wireless communication).

Note that the notification indicating that the mobile terminal 1000 has received the scanned image via light may not be transmitted via wireless communication. That is, steps S1208 and S1210 may be omitted, resulting in step S1212 being unnecessary as well. In this case, the user knows successful transmission of a scanned image by viewing a user interface display on the mobile terminal 1000. The user then performs an operation of causing the image reading device 1050 to terminate the emission of visible light. Wireless communication other than visible light communication from the mobile terminal 1000 to the image reading device 1050 requires the mobile terminal 1000 to be informed of the address of the image reading device 1050. The omission of steps S1208 and S1210 eliminates this requirement, which may make the operation simple and may eliminate or reduce potential security risks.

In step S1214, the image reading device 1050 terminates the emission of visible light. That is, visible light communication is terminated.

In step S1216, the image reading device 1050 performs a process for informing the user that the mobile terminal 1000 has received the scanned image via light (by, for example, visual indication, audio indication, or vibration). Step S1216 may be omitted.

On the other hand, the mobile terminal 1000 performs the following process.

In step K1202, a visible-light sensor is in operation. The visible-light sensor is waiting for visible light communication to be received.

In step U1204, a user operation is performed as follows. The user positions the mobile terminal 1000, which is to receive, to allow visible light emitted from the image reading device 1050 to reach the mobile terminal 1000.

The process proceeds to step K1204 after step S1210.

In step K1204, the mobile terminal 1000 determines whether or not the visible-light sensor has received visible light based on the standard for visible light communication. If visible light has been received, the process proceeds to step K1206. Otherwise, the process returns to step K1202.

In step K1206, the mobile terminal 1000 determines whether or not the received visible light includes a scanned image. If the received visible light includes a scanned image, the process proceeds to step K1208. Otherwise, the process returns to step K1202.

In step K1208, the mobile terminal 1000 informs the image reading device 1050 that the scanned image has been received via light. The image reading device 1050 may be informed via visible light communication or via wireless communication such as WiFi.

In step K1210, the mobile terminal 1000 sends a notification (visible light communication or wireless communication) indicating that the mobile terminal 1000 has received the scanned image via light to the image reading device 1050.

In step K1212, the mobile terminal 1000 performs a process for informing the user that the mobile terminal 1000 has received the scanned image via light (by, for example, visual indication, audio indication, or vibration). Step K1212 may be omitted.

In step U1206, the user finishes positioning the mobile terminal 1000 to be exposed to the visible light being emitted.

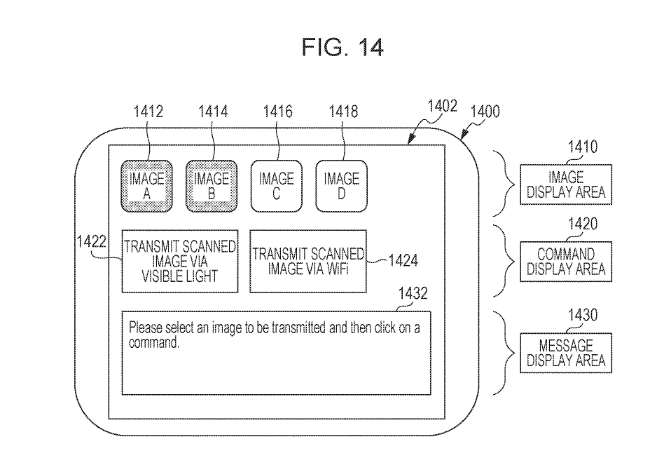

FIGS. 14 to 18 illustrate example displays on the display of the mobile terminal 1000 or the image reading device 1050.

FIG. 14 illustrates an example process (performed by the image reading device 1050) according to the second exemplary embodiment. Specifically, an example display corresponding to steps S1204 and S1206 in the flowchart is illustrated.

The image reading device 1050 includes a display device 1400 and the display device 1400 includes a display 1402. The content displayed on the display 1402 is illustrated.

The display 1402 has three areas: an image display area 1410, a command display area 1420, and a message display area 1430.

The image display area 1410 shows an “image A” icon 1412, an “image B” icon 1414, an “image C” icon 1416, and an “image D” icon 1418.

The command display area 1420 shows a “Transmit scanned image via visible light” icon 1422 and a “Transmit scanned image via WiFi” icon 1424.

The message display area 1430 shows a message display area 1432.

For example, the message “Please select an image to be transmitted and click on a command” is displayed in the message display area 1432.

Image icons and command icons are displayed on the display 1402 of the image reading device 1050. In the example in FIG. 14, the “image A” icon 1412 and the “image B” icon 1414 have been selected. Then, when the “Transmit scanned image via visible light” icon 1422 is clicked on, a transition to step S1208 in the flowchart occurs.

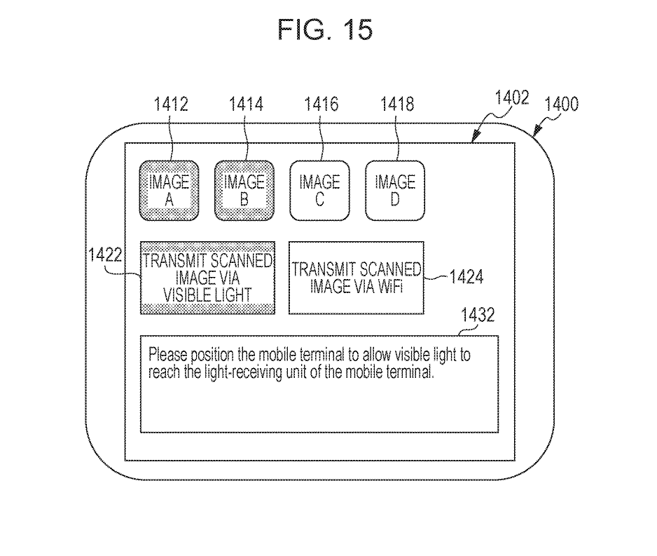

FIG. 15 illustrates an example process (performed by the image reading device 1050) according to the second exemplary embodiment. Specifically, an example display corresponding to steps S1208 and U1204 in the flowchart is illustrated.

The “Transmit scanned image via visible light” icon 1422 is being selected by the user.

Upon acceptance of the selection of the “Transmit scanned image via visible light” icon 1422, the image reading device 1050 emits light based on the standard for visible light communication (step S1208). Then, a suggestion for the user to position the mobile terminal 1000 to allow visible light to reach a light-receiving unit of the mobile terminal 1000 is displayed in the message display area 1432 as an operation to be performed by the user. For example, the message “Please position the mobile terminal to allow visible light to reach the light-receiving unit of the mobile terminal” is displayed in the message display area 1432. This display facilitates the user's understanding of the operation to be performed.

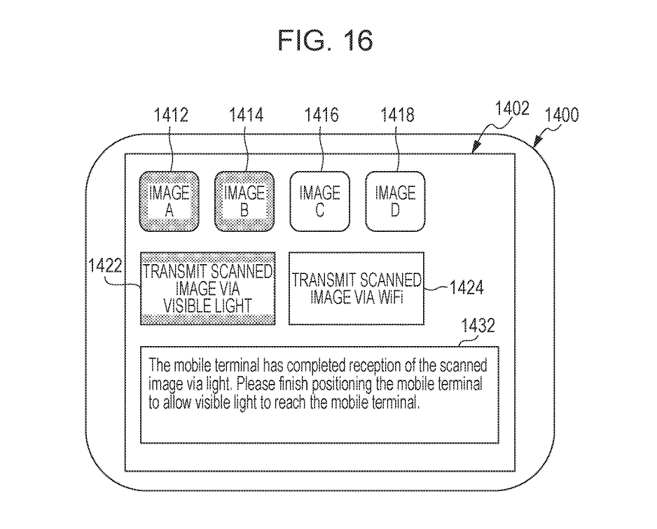

FIG. 16 illustrates an example process (performed by the image reading device 1050) according to the second exemplary embodiment. Specifically, an example display corresponding to steps S1212 to S1216 and U1206 in the flowchart is illustrated.

The “Transmit scanned image via visible light” icon 1422 is being selected by the user.

The emission of light from the image reading device 1050 is terminated (step S1214). Then, a suggestion for the user to finish positioning the mobile terminal 1000 to allow visible light to reach the mobile terminal 1000 is displayed in the message display area 1432 as an operation to be performed by the user. For example, the message “The mobile terminal has completed reception of the scanned image via light. Please finish positioning the mobile terminal to allow visible light to reach the mobile terminal” is displayed in the message display area 1432. This display facilitates the user's understanding of the operation to be performed.

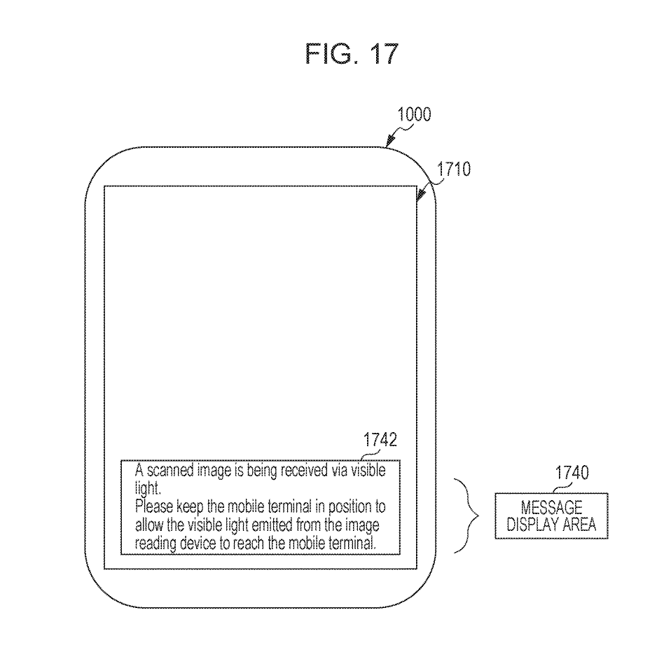

FIG. 17 illustrates an example process (performed by the mobile terminal 1000) according to the second exemplary embodiment. Specifically, an example display corresponding to steps S1210, K1204, and K1206 in the flowchart is illustrated.

The mobile terminal 1000 includes a display 1710.

The display 1710 has a message display area 1740.

The message display area 1740 shows a message display area 1742.

The mobile terminal 1000 is receiving light based on the standard for visible light communication. Then, a suggestion for the user to position the mobile terminal 1000 to allow visible light to reach the mobile terminal 1000 is displayed in the message display area 1742 as an operation to be performed by the user. For example, the message “A scanned image is being received via visible light. Please keep the mobile terminal in position to allow the visible light emitted from the image reading device to reach the mobile terminal” is displayed in the message display area 1742. This display facilitates the user's understanding of the operation to be performed.

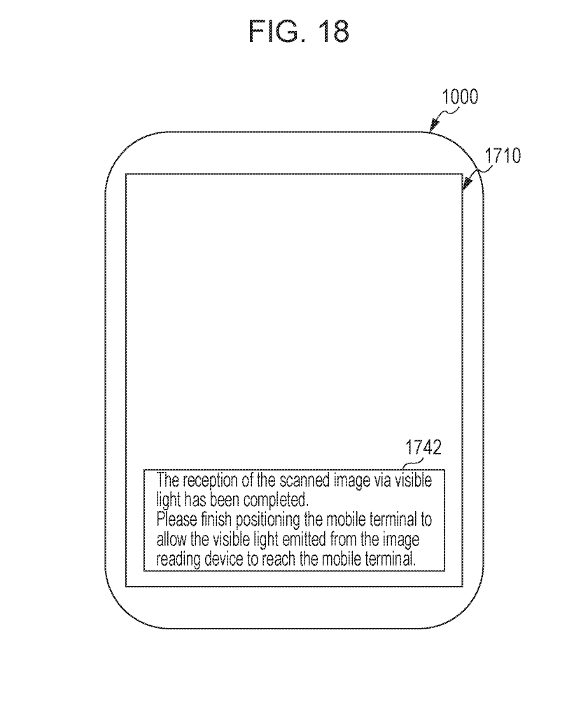

FIG. 18 illustrates an example process (performed by the mobile terminal 1000) according to the second exemplary embodiment. Specifically, an example display corresponding to steps K1212 and U1206 in the flowchart is illustrated.

When the mobile terminal 1000 completes reception of the scanned image, a suggestion for the user to finish positioning the mobile terminal 1000 to allow visible light to reach the mobile terminal 1000 is displayed in the message display area 1742 as an operation to be performed by the user. For example, the message “The reception of the scanned image via visible light has been completed. Please finish positioning the mobile terminal to allow the visible light emitted from the image reading device to reach the mobile terminal” is displayed in the message display area 1742. This display facilitates the user's understanding of the operation to be performed.

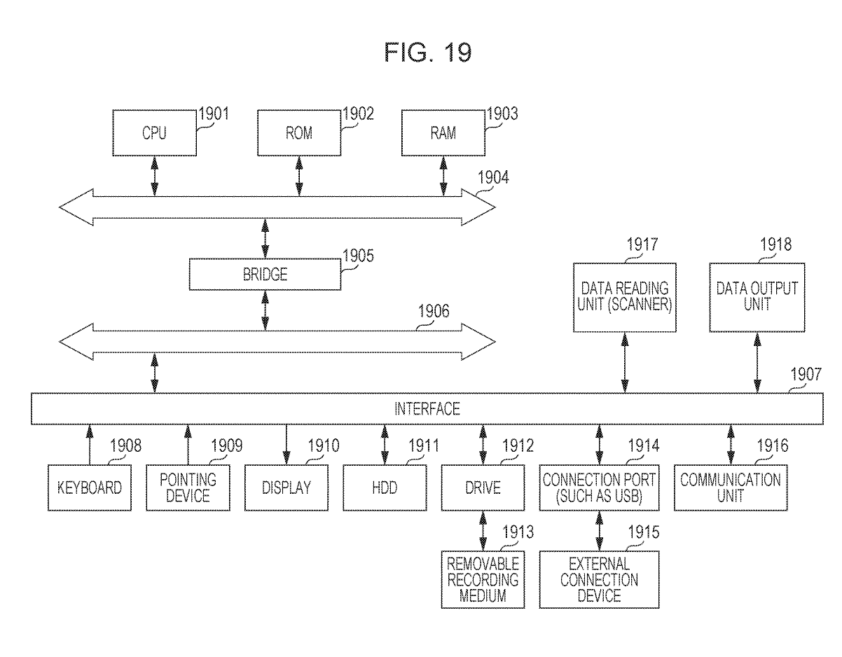

An example hardware configuration of the mobile terminal 100, the printer 150, the mobile terminal 1000, and the image reading device 1050 according to the exemplary embodiments described above will be described with reference to FIG. 19. The configuration illustrated in FIG. 19 is implemented by a personal computer (PC), for example. An example hardware configuration including a data reading unit 1917, such as a scanner, and a data output unit 1918, such as a printer, is illustrated. The mobile terminal 100 and the mobile terminal 1000 may not include the data reading unit 1917 or the data output unit 1918.

A CPU 1901 is a controller that executes processing in accordance with a computer program describing the execution sequence of the various modules described in the foregoing exemplary embodiments, namely, the visible-light transmitting module 105, the reception module 110, the communication control module 115, the user interface module 120, the visible-light receiving module 155, the transmission module 160, the communication control module 165, the user interface module 170, the print control module 175, the printing module 185, the visible-light receiving module 1005, the transmission module 1010, the communication control module 1015, the user interface module 1020, the visible-light transmitting module 1055, the reception module 1060, the communication control module 1065, the user interface module 1070, the image reading control module 1075, and the image reading module 1085.

A read-only memory (ROM) 1902 stores data used by the CPU 1901, such as programs and computation parameters. A RAM 1903 stores a program used in execution by the CPU 1901 and parameters and the like that change as appropriate in accordance with the execution of the program. The CPU 1901, the ROM 1902, and the RAM 1903 are connected to one another via a host bus 1904. The host bus 1904 is implemented as, for example, a CPU bus.

The host bus 1904 is connected to an external bus 1906 such as a Peripheral Component Interconnect/Interface (PCI) bus via a bridge 1905.

A keyboard 1908 and a pointing device 1909 such as a mouse are devices operable by an operator. A display 1910, examples of which include a liquid crystal display device and a cathode ray tube (CRT), displays various information as text and/or image information. Alternatively, the display 1910 may be a device having both the functions of the pointing device 1909 and the display 1910, such as a touch screen.

A hard disk drive (HDD) 1911 includes a built-in hard disk (or a flash memory or the like). The HDD 1911 drives the hard disk to record or reproduce information and a program to be executed by the CPU 1901. The hard disk implements the functions of the file storage module 125, the file storage module 180, the file storage module 1025, the file storage module 1080, and so on. In addition, other various data, various computer programs, and so on are also stored.

A drive 1912 reads data or a program recorded on a removable recording medium 1913 mounted on the drive 1912, such as a magnetic disk, an optical disk, a magneto-optical disk, or a semiconductor memory, and supplies the data or program to the RAM 1903 connected via an interface 1907, the external bus 1906, the bridge 1905, and the host bus 1904. The removable recording medium 1913 is also available as a data recording area.

A connection port 1914 is a port that connects an external connection device 1915, and has a connection part supporting a standard such as Universal Serial Bus (USB) or IEEE 1394. The connection port 1914 is connected to the CPU 1901 and so on via the interface 1907, the external bus 1906, the bridge 1905, the host bus 1904, etc. A communication unit 1916 is connected to a communication line to execute a process for data communication with external devices. The data reading unit 1917 may be a scanner, for example, and is configured to execute a process for reading documents. The data output unit 1918 may be a printer, for example, and is configured to execute a process for outputting document data.

The hardware configuration illustrated in FIG. 19 is an example configuration. The configurations of the exemplary embodiments described above are not limited to the configuration illustrated in FIG. 19 and may be any configuration that makes the modules described in the foregoing exemplary embodiments executable. For example, some of the modules may be implemented as dedicated hardware (such as an application specific integrated circuit (ASIC)), or some of the modules may be included in an external system and connected via a communication line. Alternatively, multiple systems each illustrated in FIG. 19 may be interconnected via a communication line so as to operate in cooperation with each other.

The program described above may be provided after being stored in a recording medium, or may be provided via a communication medium. In some exemplary embodiments, for example, the program described above may be embodied as a “computer-readable recording medium storing the program”.

The term “computer-readable recording medium storing the program” refers to a recording medium readable on a computer having the program recorded thereon, which is used for purposes such as installation and execution of the program and distribution of the program.

Examples of the recording medium include digital versatile discs (DVDs), such as discs based on standards created by the DVD Forum, namely, “DVD-R, DVD-RW, and DVD-RAM”, and discs based on standards created by the DVD+RW Alliance, namely, “DVD+R and DVD+RW”, compact discs (CDs), such as a read-only memory (CD-ROM), a CD-Recordable (CD-R) disc, and a CD-Rewritable (CD-RW) disc, Blu-ray Disc (registered trademark), a magneto-optical (MO) disk, a flexible disk (FD), a magnetic tape, a hard disk, a ROM, an electrically erasable programmable ROM (EEPROM), a flash memory, a RAM, and a secure digital (SD) memory card.

All or part of the program described above may be recorded on the recording medium for storage or distribution, for example. Alternatively, all or part of the program described above may be transmitted via communication by using a transmission medium such as a wired network, a wireless communication network, or a combination thereof that is used for a communication architecture such as a LAN, a metropolitan area network (MAN), a wide area network (WAN), the Internet, an intranet, or an extranet, or may be carried on carrier waves.

Additionally, the program described above may be part or all of another program, or may be recorded on a recording medium together with individual programs. Alternatively, the program may be divided into pieces which are recoded on plural recording media. Moreover, the program may be recorded in any form that is restorable, such as in compressed or encrypted form.

The visible light for use in visible light communication according to the exemplary embodiments described above may be diffused visible light, such as illumination of a ceiling light, or converging visible light, such as illumination of a flashlight. Converging visible light is easier for a user to use than diffused visible light since converging visible light is easier to apply only to the desired destination.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A mobile information processing device comprising:
a transmitting unit that transmits a print instruction to a light-receiving unit of an image output device via visible light communication; and
a providing unit that suggests to a user an operation of projecting visible light onto the image output device when the print instruction is to be transmitted to the light-receiving unit via the visible light communication.

2. An image output device comprising:
a light-receiving unit;
a receiving unit that receives, by using the light-receiving unit, a print instruction from a mobile information processing device via visible light communication; and
a providing unit that suggests to a user an operation of projecting visible light onto the image output device when the print instruction is to be received from the mobile information processing device via the visible light communication.

3. An image output system comprising:
a mobile information processing device; and
an image output device including a light-receiving unit,
the mobile information processing device including
a transmitting unit that transmits a print instruction to the light-receiving unit of the image output device via visible light communication, and
a providing unit that suggests to a user an operation of projecting visible light onto the image output device when the print instruction is to be transmitted to the light-receiving unit via the visible light communication,
the image output device further including
a receiving unit that receives, by using the light-receiving unit, the print instruction from the mobile information processing device via the visible light communication, and
a providing unit that suggests to the user an operation of projecting visible light onto the image output device when the print instruction is to be received from the mobile information processing device via the visible light communication.

4. A mobile information processing device comprising:
at least one of an imaging light source or a display; and
a transmitting unit that transmits a print instruction to an image output device via visible light communication which uses the at least one of the imaging light source or the display.

5. The mobile information processing device according to claim 4, further comprising a camera, wherein
the transmitting unit is oriented in a direction identical to a direction in which the camera points.

6. The mobile information processing device according to claim 5, further comprising the display, wherein
an image captured with the camera is displayed on the display when the transmitting unit is to perform transmission via the visible light communication.

7. An image output system comprising:
a mobile information processing device; and
an image output device,
the mobile information processing device including
at least one of an imaging light source or a display, and
a transmitting unit that transmits a print instruction to the image output device via visible light communication which uses the at least one of the imaging light source or the display,
the image output device including
a receiving unit that receives the print instruction from the mobile information processing device via the visible light communication.

8. The mobile information processing device according to claim 1, wherein the transmitting unit transmits the print instruction to the image output device without accepting an operation of the user for selecting the image output device, which is a destination of the print instruction.

9. The mobile information processing device according to claim 4, wherein the transmitting unit transmits the print instruction to the image output device without accepting an operation of the user for selecting the image output device, which is a destination of the print instruction.

10. The image output device according to claim 2, wherein communication setting information on the mobile information processing device from which the print instruction has been transmitted via the visible light communication is not set in the image output device.

11. The image output device according to claim 2, wherein information indicating that the receiving unit has received the print instruction from the mobile information processing device is not transmitted to the mobile information processing device.

12. The mobile information processing device according to claim 1, wherein the providing unit further provides information indicating receipt of the print instruction, upon receipt of the information from the image output device.

13. The mobile information processing device according to claim 4, further comprising:
a providing unit that provides information indicating receipt of the print instruction, upon receipt of the information from the image output device.

14. An image reading device comprising:
a transmitting unit that transmits a read image to a camera included in a mobile information processing device via visible light communication.

15. A mobile information processing device comprising:
a camera; and
a receiving unit that receives, by using the camera, an image from an image reading device via visible light communication.

16. An image reading system comprising:
an image reading device; and
a mobile information processing device including a camera,
the image reading device including
a transmitting unit that transmits a read image to the camera of the mobile information processing device via visible light communication,
the mobile information processing device further including
a receiving unit that receives, by using the camera, the image from the image reading device via the visible light communication.

17. The image reading device according to claim 14, wherein the transmitting unit transmits the image to the mobile information processing device without accepting an operation of a user for selecting the mobile information processing device, which is a destination of the image.

18. The mobile information processing device according to claim 15, wherein communication setting information on the image reading device from which the image has been transmitted via the visible light communication is not set in the mobile information processing device.

19. The mobile information processing device according to claim 15, wherein information indicating that the receiving unit has received the image from the image reading device is not transmitted to the image reading device.

20. The image reading device according to claim 14, further comprising:
a providing unit that provides information indicating receipt of the image, upon receipt of the information from the mobile information processing device.

21. The mobile information processing device according to claim 1, further comprising:
a camera; and
a receiving unit that receives, by using the camera, an image from an image reading device via visible light communication.

22. The mobile information processing device according to claim 4, further comprising:
a camera; and
a receiving unit that receives, by using the camera, an image from an image reading device via visible light communication.

23. The mobile information processing device according to claim 1, wherein the visible light communication uses converging visible light.

24. The mobile information processing device according to claim 4, wherein the visible light communication uses converging visible light.

25. A non-transitory computer readable medium storing a program causing a computer to execute a process for processing information, the process comprising:
transmitting, by a mobile information processing device, a print instruction to a light-receiving unit of an image output device via visible light communication; and
suggesting, by the mobile information processing device, to a user an operation of projecting visible light onto the image output device when the print instruction is to be transmitted to the light-receiving unit via the visible light communication.

26. A non-transitory computer readable medium storing a program causing a computer to execute a process for outputting an image, the process comprising:
receiving, by a light-receiving unit of an image output device, a print instruction from a mobile information processing device via visible light communication; and
suggesting, by the image output device, to a user an operation of projecting visible light onto the image output device when the print instruction is to be received from the mobile information processing device via the visible light communication.

27. A non-transitory computer readable medium storing a program causing a computer to execute a process for processing information, the process comprising:
transmitting, by a mobile information processing device including at least one of an imaging light source or a display, a print instruction to an image output device via visible light communication which uses the at least one of the imaging light source or the display.

28. A non-transitory computer readable medium storing a program causing a computer to execute a process for reading an image, the process comprising:
transmitting, by an image reading device, a read image to a camera included in a mobile information processing device via visible light communication.

29. A non-transitory computer readable medium storing a program causing a computer to execute a process for processing information, the process comprising:
receiving, by using a camera included in a mobile information processing device, an image from an image reading device via visible light communication.
